(19) United States
(12) Patent Application Publication
(10) Pub. No.: US 2010/0021662 A1
(43) Pub. Date: Jan. 28, 2010

(54) METHOD FOR THE PREPARATION OF COATING FORMULATIONS AND PAPERS COATED THEREWITH

(76) Inventors: Roland Stephan, Alfeld (DE); Axel Laber, Alfeld (DE); Detlef Spyra, Winzenburg (DE); Peter Resch, Vasoldsberg (AT); Mikel Van Avermaete, Heerten (NL)

Correspondence Address: SUGHRUE MION, PLLC, 2100 PENNSYLVANIA AVENUE, N.W., SUITE 800, WASHINGTON, DC, 20037, US

(21) Appl. No.: 12/525,786

(22) PCT Filed: Jan. 30, 2008
(86) PCT No.: PCT/EP08/00713

§ 371 Date: Aug. 20, 2009

(30) Foreign Application Priority Data
Feb. 6, 2007 (EP) 07405033.7

(51) Int. Cl. B41M 5/50; C09D 11/02; C08K 3/26; C08K 3/34

(52) U.S. Cl. 428/32.1; 106/31.85; 106/31.65; 524/425; 524/446

(57) ABSTRACT

A method for the preparation of a silica slurry in water is described. The proposed silica slurry can be advantageously used as a constituent of a coating formulation for a paper comprising precipitated silica and/or silica gel as well as at least one further fine particulate pigment, in particular for an offset paper. The method includes, in the given sequence, the steps a) making a dispersion of the at least one further fine particulate pigment in water, b) adding the silica in dry powdery form to that dispersion.

### TECHNICAL FIELD

The present invention relates to a method for the preparation of a silica slurry in water. It specifically relates to such a method to be applied in the context of making a slurry of silica in particular silica gel, to be used for coating formulations particularly for offset papers. It furthermore relates to methods for making coating formulations using such a silica slurry, and to papers coated with such a coating formulation.

### BACKGROUND OF THE INVENTION

In the field of sheet fed offset printing it is desirable to be able to further process a freshly printed sheet as quickly as possible, while at the same time still allowing the printing inks to settle in and on the surface of the paper in a way such that the desired print gloss and the desired resolution can be achieved. Relevant in this context are on the one hand the physical ink drying process, which is connected with the actual absorption of the ink vehicles into an image receptive coating, e.g. by means of pores or a special system of fine pores provided therein. On the other hand there is the so-called chemical drying of the ink, which is connected with solidification of the ink in the surface and on the surface of the ink receptive layer, which normally takes place due to an oxidative cross-linking (oxygen involved) of cross linkable constituents of the inks. This chemical drying process can on the one hand also be assisted by IR-irradiation, it may however also be sped up by adding specific chemicals to the inks which catalytically support the cross-linking process. The more efficient the physical drying during the first moments after the application of the ink, the quicker and more efficient the chemical drying takes place.

Nowadays typically times until reprinting and converting times in the range of several hours (typical values until reprinting for standard print layout: about 1-2 h; typical values until converting for standard print layout: 12-14 h; matt papers are more critical than glossy papers in these respects), which is a severe disadvantage of the present ink and/or paper technology, since it slows down the printing processes and makes intermediate storage necessary. Today shorter times are possible if for example electron beam curing or UV irradiation is used after the printing step, but for both applications special inks and special equipment is required involving high costs and additional difficulties in the printing process and afterwards.

One possible way to decrease the typical printing times in offset printing processes has been described in a recent publication EP-A-1 743 976. In this document it is proposed to use particulate silica not as a main constituent of the coating formulation (top coating and/or undercoat) in order to decrease the drying time in offset printing processes. The particulate silica mentioned there is stated to include compounds commonly referred to as silica sol, as well as colloidal silica and fumed silica, and preferably also amorphous silica gel as well as precipitated silica. Substantially shortened drying times and times until converting is possible, can be achieved.

One problem associated with the use of silica as a pigment is the fact that in particular if silica gel is used, it is essential to bring the initially powdery raw material into a water dispersion together with the further pigments which form part of the coating formulation. To do that the powdery raw material (silica gel or precipitated silica) is at first dispersed in water (if need be with addition of dispersants), and since the silica has a very particular powder and surface structure (high surface area and moderate wettability, low bulk density, high capability of liquid uptake), which actually leads to the beneficial printing properties, this dispersion process is time-consuming and leads to a silica slurry with a rather low solids content. For example, the powder has the tendency to swim on top of the mixing tank and it is difficult to actually bring the powder below the surface. Furthermore it forms clusters with a wetted surface and a dry core. To break up these clusters necessitates a high intake of mechanical agitation energy over a long time span. So usually special dispersion plants are necessary to actually bring silica gel into such a slurry state. Furthermore, a silica slurry prepared in such a process is not very stable and cannot be stored for a long time, and bringing it into a proper state after having been stored beyond a certain time limit is very difficult if not impossible. This preprepared silica slurry is therefore quite quickly subsequently introduced into the coating formulation making process, so subsequently the further pigments (usually calcium carbonate, kaoline, clay, possibly also (solid or hollow) plastic pigments), these further pigments finally making up the main constituent of the coating formulation, are added, usually also as a preprepared slurry together with the necessary additional constituents like binders and further additives (like brightener, rheology modifiers etc.). Furthermore only low solids contents can be achieved when using this method, leading to long drying times in the papermaking process.

### SUMMARY OF THE INVENTION

The objective of the present invention is therefore to provide a method for making coating formulations comprising silica, in particular comprising silica gel or precipitated silica. Specifically, an improved method for the preparation of a silica slurry in water to be used as a constituent of a coating formulation for a paper comprising precipitated silica and/or silica gel as well as at least one further fine particulate pigment, in particular for an offset paper, shall be given.

The present invention achieves the above problem by proposing a method, which includes, in the sequence as given, the steps of a) making or providing a dispersion of the at least one further fine particulate pigment in water, b) adding the silica in dry powdery form to that dispersion.

It should be noted that the same is equivalently possible if one uses a dispersion as made in step a) as starting material and then in one single step the method is carried out as step b).

One of the key features of the invention is therefore the finding that it is surprisingly and unexpectedly possible and very beneficial to reverse or rather change the classical order of first making a silica slurry and then adding this slurry to a slurry comprising the further pigments.

As a matter of fact, it was recognised that a high dispersion energy has to be introduced into the system (mixing energy in the dispersion plant) for making a silica dispersion for the reasons already outlined above. Indeed, for making a silica slurry in water, even if dispersants are added for making a silica slurry in water, heavy stirring is necessary for at least 4 to 8 hours, and the silica slurry obtained in such a dispersion process when then finally used for making the final coating formulation leads to coating formulations with a rather low solids content. This was always accepted as one of the drawbacks of making coating formulations with precipitated silica or silica gel in particular.

Unexpectedly however it was now found that if in a first step one makes a dispersion of a further pigment present in the final coating formulation (or if equivalently one uses such a dispersion as starting material) and then adds the silica in powdery form to this dispersion, surprisingly the dispersion process is exceedingly more efficient.

On the one hand it is possible to disperse more silica gel or precipitated silica into the dispersion, and on the other hand the energy required for dispersing the silica gel or the precipitated silica and correspondingly the time for the dispersion process can be reduced dramatically.

At present an explanation for this is that the further pigment already present in the dispersion acts as a dispersion aid, most likely in the sense that the pigment particles of the further pigments act like stirring aids almost on a mechanical level.

Using the proposed method, the time for making a silica slurry can be reduced to an hour or less (reduction of approximately 80%!), and furthermore higher solid contents can be achieved, this under conditions, where silica is present in the slurry in an amount making up at least 5 weight % (dry weight) of the total pigment in the slurry (which means that the rest of the pigment in the slurry, e.g. the calcium carbonate pigment, makes up 95 weight %), preferably under conditions, where silica is present in the slurry in an amount making up above than or equal to 8 or 10 weight % of the total pigment in the slurry, preferably in the range of 8-15 weight %. Under these conditions it is now possible to raise the solids content of the silica slurry resulting from the process or of the final coating formulation to a value of above than or equal to 65%, which is, using the conventional process, simply impossible.

This higher solids content leads to shorter drying times on the machine since less water has to be removed from the coating after application of the coating formulation. In turn this allows to run the paper machine faster leading to a higher paper production speed. Furthermore, the high solids content leads to a better quality and a better coating coverage since there is less water penetration leading, among other advantages, to a higher gloss in particular in case of glossy papers.

Furthermore such as silica slurry which already comprises further pigments is unexpectedly storable for much longer times, typically for at least for 20 days, than a slurry comprising silica only, eventually with dispersants.

Generally the present method is suitable and optimised for making coating formulations as described and claimed in the above-mentioned EP-A-1743976. Correspondingly therefore, the content of this document is explicitly included into this disclosure as concerns the composition of formulations and the characteristics of the constituents thereof.

The proposed method provides a silica slurry which can subsequently be introduced into the coating formulation making process. In this case, the resulting silica (gel) slurry serves as a starting material for the coating formulation making process, during which then eventually further pigments are introduced, brighteners, the binders etc.

On the other hand it is also possible to incorporate the proposed method into the coating formulation making process. It is for example possible to introduce the silica as proposed here directly into the dispersion tank of the coating formulation making unit of the paper machine, by for example pneumatically blowing the silica powder into this dispersion tank in which there is also a dispersion with a further pigment present.

In a first preferred embodiment of the present invention, the silica is an amorphous silica gel. Making dispersions of amorphous silica gel is particularly difficult, and it was found that in particular for this situation the present methods is most suitable. This holds particularly true, if the silica gel to be dispersed has an internal pore volume above 0.5 ml/g, preferably above 1.0 ml/g, even more preferred above or equal to 1.5 or 2.0 ml/g. Equally or alternatively this holds true if the silica gel used has a surface area in the range of 200-1000 m²/g, preferably in the range of 250-800 m²/g, even more preferably in the range of 200-400 m²/g. Equally or alternatively, it holds true if the silica gel has a particle size in the range of 0.1-5 μm, preferably in the range of 0.3-4 μm, particularly in the range of 0.3-1 μm or in the range of 3-4 μm.

As already mentioned above, the further pigment acts as a dispersion aid as it provides kinetic energy in the dispersion at a particulate level. To achieve this effect the dispersion of the further pigment is preferably rather heavily loaded with such particulate pigment. Preferably therefore, the further fine particulate pigment(s) are present after step a) in a dispersion with a solids content above 50%, preferably above 60%, even more preferably in the range of 70 to 80%.

A further preferred embodiment of the method is characterised in that the further fine particulate pigment(s) are selected from the group of: calcium carbonate, kaoline, clay, plastic pigment, or a mixture thereof. Preferred is calcium carbonate, so preferably the further fine particulate pigment used in or provided as step a) essentially consists of calcium carbonate, preferably with a particle size distribution such that 50% of the particles are smaller than 1 μm, even more preferably with a particle size distribution such that 50% of the particles are smaller than 0.5 μm, and most preferably with a particle size distribution such that 50% of the particles are smaller than 0.4 μm. If the final coating formulation comprises still further pigments, either of completely different type or calcium carbonate with a different particle distribution, these can also be added after the making of the silica slurry.

Preferably, prior to step a) additionally a dispersant is used, preferably a polyacrylate and/or polyphosphate dispersant or other dispersants currently available for dispersing pigments in water.

It should be pointed out that preferably the proposed method for making a silica slurry is carried out in the absence of binder for the final coating formulation. So in step a) essentially no binder of the final coating formulation is present yet, and the binder is only added after the preparation of the silica slurry. Indeed, the proposed silica slurry can be used as a preprepared constituent of a final coating formulation, which can be stored for a comparably long time. The final coating formulation can then be made by adding further pigments, additives, binders, etc shortly before applying the coating formulation to the substrate, which can be for example a standard on coated or precoated (e.g. with sizing layer) substrate.

According to a further preferred embodiment prior to step a) additionally an alkaline is added, preferably to adjust the pH at the end of step a) to be above 7, even more preferably in the range of pH=7.5-8.7 (target value typically pH˜8.2), wherein preferably sodium hydroxide solution is used as alkaline to this end. The adjustment of the pH to these values is particularly important if calcium carbonate is used as pigment since if the pH props to values too low, gas formation starts to initiate.

As a matter of fact, cluster formation can efficiently be prevented if in a very first and initial step water is provided comprising dispersant as well as alkaline, and subsequently a slurry comprising the further pigment is introduced into the system.

A specific preferred embodiment of the present invention is characterised in that in step a) water making up typically 20-50 or 20-40 weight-% of the weight of the total final wet coating formulation is introduced into a mixing tank, if need be preceded, accompanied or followed by introduction of dispersants and/or alkaline, followed by the addition of (typically a main part) of the calcium carbonate pigment part of the final coating formulation. The amount of calcium carbonate added in step a preferably such that in the total final dry coating formulation its content is the range of 50-95 weight-%, even more preferably in the range of 70-90 weight-% of the total final dry coating formulation, and then this slurry is agitated until the formation of an essentially homogeneous dispersion has taken place Subsequently step b) is carried out.

According to a preferred embodiment the silica is essentially continuously or intermittently continuously added to the dispersion in step b). Preferably, the addition takes place in an essentially continuous manner, by blowing silica powder in essentially dry state into the pigment dispersion made in step a). Preferably therefore, the silica (gel) powder is introduced into the system using pneumatic assistance. This means that e.g. pressurised air is used for providing a stream of air mixed with silica particles as homogeneously as possible for the introduction into the dispersion (“blowing in”). This is for example possible by providing a pipe with pressurised air with an inlet for powder leading to a mixing of powder and air and the air thus carries the powder into the dispersion plant. In order to avoid problems with powder in the surrounding atmosphere of the dispersion plant, it is advantageous to provide corresponding injection valves for the powder/air mixture in and/or close to the top cover of the dispersion tank. The speed of adding the silica powder can be adjusted by monitoring the agitator in the dispersion plant. Efficient control of the addition can be effected if the speed of addition is adjusted such that the agitator in the mixing tank is able to continuously maintain a mixing speed well above zero or above a certain minimum value.

For the preparation of the above-mentioned preprepared silica slurry to be subsequently used for making of the coating formulation it is possible to supplement the silica slurry made in step b) by some additional water in order to adjust the final solids content and to agitate the system some more to achieve a homogeneous system. Generally, it is possible to achieve a final solids content of the silica slurry is in the range of 40-70%, preferably in the range of 50-70%, even more preferably in the range of 60-65%.

As already mentioned above, the proposed method provides a method for making a preprepared silica slurry. The final coating formulation is typically only made in a subsequent step, so preferably after step b) eventually additional pigments (for example coarser calcium carbonate pigments kaoline, clay or the like, typically not making up more than 5-20 weight % of the final dry weight of the coating, as well as further additives are added Binder is, as already outlined above, only added for making up the final coating formulation later so after the making of the silica slurry. Typically the binder is added such as to lead finally to a dry weight of the final drive coating formulation in the range of 5-20, preferably 7-12, parts in dry weight.

As already outlined above, typically, particularly for offset coating applications, the silica content in the slurry and in the final coating formulation is below the content of further pigment. Preferably therefore in step b) silica gel is added in an amount such that in the final coating formulation 3-20 parts, preferably 8-12 parts in dry weight is present.

The present invention furthermore relates to a silica slurry made in accordance with the above methods, as well as to a method for making a coating formulation, which is characterised in that a preprepared silica slurry is made using a method as given above is used. It furthermore relates to a coating formulation made using such a method. Last but not least it relates to a coated paper, preferably a coated offset printing paper, comprising at least one coating layer on at least one side made by using such a coating formulation.

Further embodiments of the present invention are outlined in the dependent claims.

### SHORT DESCRIPTION OF THE FIGURES

In the accompanying drawings preferred embodiments of the invention are shown in which:

FIG. 1 is a schematic view of a dispersion plant with two mixing tanks for use in the context of the present invention; and

FIG. 2 a) is a schematic view of a dispersion plant with one mixing tank for use in the context of the present invention.

### DETAILED DESCRIPTION OF THE PREFERRED EMBODIMENTS

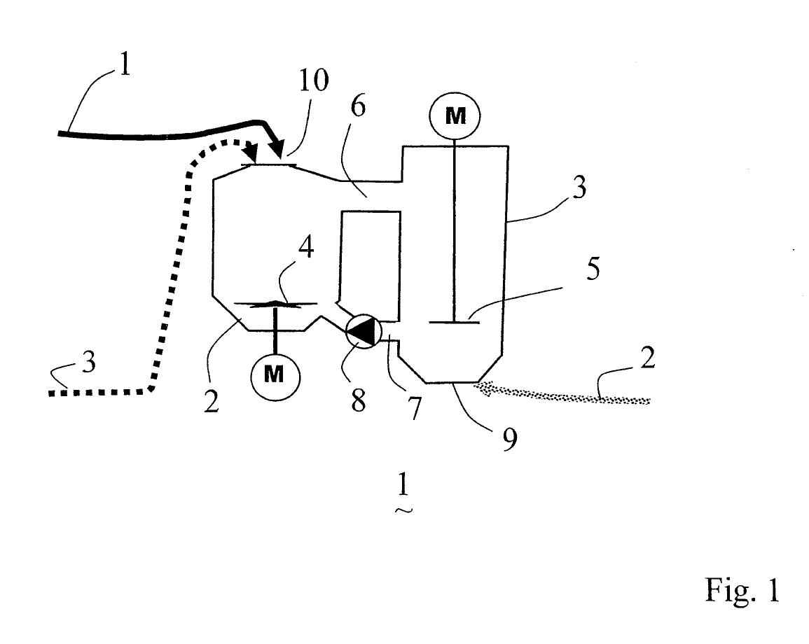

Referring to the drawings and the specific examples, which are for the purpose of illustrating the present preferred embodiments of the invention and not for the purpose of limiting the same, FIG. 1 shows a dispersion plant 1 comprising a primary mixing tank 2 and a secondary mixing tank 3. In both mixing tanks agitators 4 and 5 are provided, each of them driven by a motor M. The agitators are preferably agitators with a high dispersive action, as they are known for disbursing pigments in water. They can for example be located near the bottom of the tank. The primary mixing tank is the actual dispersion tank, while the secondary mixing tank is usually called the circulation tank.

The two mixing tanks are interconnected via two conduits 6 and 7 which allowed to circulate the liquid in the two containers 2 and 3 on the one hand assisted by the two agitators 4 and 5, but specifically by means of the pump 8 (so called cyclisation vat).

In the setup according to FIG. 1 water and possible additional chemicals (dispersants in particular) are added to the primary mixing tank in a first step (1 in circle). Calcium carbonate is added as a slurry in a second step to the secondary mixing tank 3, which can take place either subsequently or at the same time as the first step (2 in circle). In the actual second method step as detailed above subsequently then the silica gel is added by blowing in the powder into the primary mixing tank.

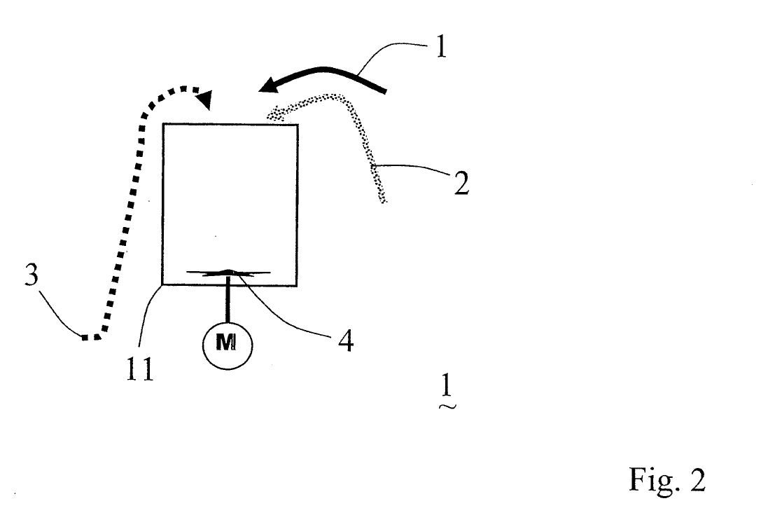

A different setup is given in FIG. 2, here there is only one single container 11 with one single agitator 4. As one can see from the figure, the above three different additions of constituents take place into that one single container.

The silica slurry produced in such a dispersion plant is therefore made in accordance with the present invention in that the silica powder is introduced into a ready pigment slurry (usually calcium carbonate slurry), which as a result allows to have silica pigment in a coating formulation with a solids content of 65% which is usual for coating formulations, and which beforehand could not be achieved with silica slurries, in particular with silica gel slurries.

As mentioned above, in an initial step, dispersant, typically a polyacrylate or polyphosphate dispersant, as well as an appropriate amount of alkaline (typically sodium hydroxide) to adjust the pH and to a value of 8.2 is provided together with water in the above step 1 in FIGS. 1 and 2. The water together with the water content in the calcium carbonate slurry introduced into the system in step 2 makes up approximately 30% of the total water amount in the slurry. In the next step (2 in circle in FIGS. 1 and 2) the calcium carbonate is introduced, typically in slurry form. This leads to a dispersion of approximately 70-80% solids content. This dispersion is agitated for some time until no clusters are present any more.

Subsequently (step 3 in circle in FIGS. 1 and 2) the silica powder (in essentially dry state) is introduced. This is effected by blowing the silica powder, for example the product SYLOID C803 or Sylojet 701A or 703A from Grace into the tank 2 or 11, respectively. The introduction of this powder takes place rather slowly, and it can be adjusted depending on the power of the dispersion aggregate. One simple way to control the addition is to monitor the behaviour of the agitators 4 and 5. If these agitators start to either become exceedingly slow or to even stop, the addition or rather blowing in of silica powder should be reduced or even stopped temporarily.

In a subsequent step, it is possible to add further water in order to adjust the final desired solids content, for example to a value of 65%. Usually after this additional water introduction it is advantageous if the system is stirred some more time (e.g. up to 30 minutes).

Total dispersion time using this method is approximately 1 hour. As a comparison, dispersion times for making a silica slurry in water, in which there is no additional further pigment present yet, takes at least 4 to 8 hours. Dispersion time can thus be reduced by about 80%.

In contrast to the silica slurries according to the state-of-the-art which are provided in water (usually in combination with dispersants) a silica slurry with further pigmentmade in accordance with the present invention can be stored over a long time. Storage times of at least 20 days are easily possible. Typically a conventional silica slurry in water only can only be stored for a few days.

Such a silica slurry can then be used for the making of the actual coating formulation in the coating aggregate of the paper machine. To this end, further pigment are added, additives like for example brighteners, rheology modifiers etc, as well as, importantly, the binder.

Specifically, it is for example possible to produce a silica slurry with silica gel (Syloid C803) and a calcium carbonate with a fine particle structure (e.g. CC90), wherein silica gel is added such that in the final coating formulation a dry content of 10% is achieved, and wherein the fine calcium carbonate is added such that in the final coating formulation a dry content of 80% is achieved. This slurry can then be stored. Subsequently, in the actual coating formulation making process just before applying the coating to the substrate, further pigment is added (for example a more coarse calcium carbonate of the type CC60 or a plastic pigment) as well as binder.

The solids content which can be achieved using this method is much higher than if for the making of the coating formulation a silica slurry in water without further pigment is used. As a matter of fact, in the final coating formulation the achievable solids content is approximately 5% higher than if a preprepared conventional silica slurry in water is used.

### LIST OF REFERENCE NUMERALS

1 dispersion plant
2 primary mixing tank
3 secondary mixing tank
4 agitator in 2
5 agitator in 3
6 first circulation conduit
7 second circulation conduit
8 pump
9 opening for introduction of further pigments into secondary mixing tank
10 opening for introduction of silica pigments into primary mixing tank
11 single mixing tank
M motor for agitator

1. A method for the preparation of a silica slurry in water to be used as a constituent of a coating formulation for a paper comprising precipitated silica and/or silica gel as well as at least one further fine particulate pigment, in particular for an offset paper, including, in the given sequence, the steps
a) making or providing a dispersion of the at least one further fine particulate pigment in water,
b) adding the silica in dry powdery form to that dispersion.

2. Method according to claim 1, wherein the silica is an amorphous silica gel.

3. Method according to claim 2, wherein the silica gel has an internal pore volume above 0.5 ml/g.

4. Method according to claim 1, wherein the further fine particulate pigment(s) are present after step a) in a dispersion with a solids content above 50%.

5. Method according to claim 1, wherein the further fine particulate pigments are selected from the group of: calcium carbonate, kaoline, clay, plastic pigment, or a mixture thereof.

6. Method according to claim 5, wherein the further fine particulate pigment used in step a essentially consists of calcium carbonate.

7. Method according to claim 5, wherein prior to or during step a) additionally a dispersant is used or introduced.

8. Method according to claim 5 wherein in step a) essentially no binder of the final coating formulation is present in the dispersion yet, and wherein the binder is only added after the preparation of the silica slurry.

9. Method according to claim 5, wherein prior to step a) an alkaline is added, to adjust the pH during and/or at the end of step a) to be above 7.

10. Method according to claim 1, wherein in step a) water making up 20-40 weight-% of the weight of the total final silica slurry or of the total final wet coating formulation is introduced into a mixing tank, preceded, accompanied or followed by introduction of dispersants and/or alkaline, followed by the addition of a main part of the calcium carbonate pigment part of the final coating formulation, agitating this slurry until the formation of an essentially homogeneous dispersion, and subsequently carrying out step b).

11. Method according to claim 1, wherein in step b) the powdery silica is blown into the pigment dispersion, by using pneumatic assistance.

12. Method according to claim 1, wherein the silica slurry is eventually subsequently supplemented by some additional water in order to adjust the final solids content, and wherein the final solids content of the silica slurry is in the range of 40-70%.

13. Method according to claim 1, wherein the dispersion time for steps a) and b) is less than or equal to an hour.

14. Method according to claim 1, wherein after step b) eventually additional pigments as well as further additives are added, and wherein binder is added for making up the final coating formulation, in a range of 5-20, parts in dry weight of the final dry coating formulation.

15. Method according to claim 1, wherein in step b) silica gel is added in an amount such that in the final coating formulation 5-15 parts in dry weight of the pigment part of the final dry coating formulation is present.

16. Method for making a coating formulation, wherein a preprepared silica slurry made using a method according to claim 1 is used.

17. Coating formulation made using a method according to claim 16.

18. Coated offset printing paper, comprising at least one coating layer on at least one side made by using a coating formulation according to claim 17.

19. Silica slurry comprising a further pigment, made using a method according to claim 1.

20. Silica gel slurry, comprising a further pigment, made using a method according to claim 1.

21. Method according to claim 2, wherein the silica gel has an internal pore volume above or equal to 1.5, and wherein it has a surface area in the range of 250-800 m²/g, and wherein it has a particle size in the range of 0.3-1 μm or in the range of 3-4 μm.

22. Method according to claim 1, wherein the further fine particulate pigment(s) are present after step a) in a dispersion with a solids content in the range of 70 to 80%.

23. Method according to claim 5, wherein the further fine particulate pigment used in step a essentially consists of calcium carbonate, with a particle size distribution such that 50% of the particles are smaller than 0.4 μm.

24. Method according to claim 5, wherein prior to or during step a) additionally a polyacrylate or polyphosphate dispersant is added.

25. Method according to claim 5 wherein in step a) essentially no binder of the final coating formulation is present in the dispersion yet, and wherein the binder is only added after the preparation of the silica slurry, in a subsequent process of the preparation of the final coating formulation.

26. Method according to claim 5, wherein prior to step a) an alkaline is added, to adjust the pH during or at the end of step a) to be in the range of pH=7.5-8.7, wherein sodium hydroxide solution is used as alkaline to this end.

27. Method according to claim 1, wherein in step a) water making up 20-40 weight-% of the weight of the total final silica slurry or of the total final wet coating formulation is introduced into a mixing tank, preceded, accompanied or followed by introduction of dispersants or alkaline, followed by the addition of a main part of the calcium carbonate pigment part of the final coating formulation, in the range of 70-90 weight-% of the pigment part of the total final dry coating formulation, agitating this slurry until the formation of an essentially homogeneous dispersion, and subsequently carrying out step b).

28. Method according to claim 1, wherein in step b) the powdery silica is blown into the pigment dispersion, by blowing the powdery silica from the top onto the surface of the dispersion, and wherein the speed of addition is adjusted such that the agitator in the mixing tank is able to continuously maintain a mixing speed well above zero.
